(19) United States
(12) Patent Application Publication
(10) Pub. No.: US 2002/0134732 A1
(43) Pub. Date: Sep. 26, 2002

(54) Apparatus and method for the purification of water

(75) Inventors: Peter Wiseburgh, Jerusalem (IL); Gerald Tanny, Rehovot (IL); Peter Hulley, Peterborough (GB)

Correspondence Address: Attention of Gregory A. Sebald, MERCHANT & GOULD P.C., P.O. Box 2903, Minneapolis, MN, 55402-0903, US

(73) Assignee: Soda-Club (CO2) Atlantic GMBH, Neugasse (CH)

(21) Appl. No.: 10/094,348

(22) Filed: Mar. 8, 2002

Related U.S. Application Data
(63) Continuation of application No. 09/540,706, filed on Mar. 31, 2000, now abandoned.
Application No. 09/540,706 is a continuation of application No. PCT/IL98/00469, filed on Sep. 28, 1998.

(30) Foreign Application Priority Data
Oct. 5, 1997 (IL) 121883

(51) Int. Cl. B01D 35/14

(52) U.S. Cl. 210/739; 210/87; 210/137; 210/138; 210/490

(57) ABSTRACT

A domestic apparatus for purifying drinking water, comprising a feed water inlet and a purified water outlet, a filter device comprising prefilter means (52) and microporous membrane filter means (53) interposed between said inlet and said outlet, and means for driving the water through said filter at a constant flow rate (51). A method of purifying drinking water, which comprises causing the water to flow at a constant flow rate through a purification filter device comprising prefilter means and microporous membrane filter means.

### FIELD OF THE INVENTION

This invention relates to an apparatus for purifying water, that is or may be infected by microorganisms, and rendering it potable and to a method of operating said.

### BACKGROUND OF THE INVENTION

In many localities, no safe and reliable water supply is available. A water distribution system may be lacking, or, frequently, such a system may exist but deliver water that is not or may not be safe and fit for drinking because it is contaminated, particularly by microorganisms. The problem of providing safe, potable water in such localities, has received wide attention and found a variety of solutions in the art.

Filtration is one of the means that can be used. In most cases, the filters used in water purification apparatus operate at constant pressure mode, via a filter is placed on a source of constant pressure and allowed to filter water until its rate of filtration is below some predetermined unacceptable value. In some cases, some degree of flow rate control is provided. For instance, U.S. Pat. No. 5,503,735 discloses a liquid purification system which provides a reverse osmosis filter membrane in a filter cartridge. Not all of the water passes through the membraae and the water not passing through the membrane passes through a pressure relief valve which can be adjusted to vary the water pressure and flow rates in the system. Devices which maintain a constant flow rate and variable pressures are employed in the systems in which water flows, for instance, in irrigation systems. Processes for controlling the flow-through speed of the filter infiltration devices are also known. One such device is described in U.S. Pat. No. 5,238,559.

JP 05185070 (Kokai No. 5-185070) notes that in domestic water purifiers the filter module must be replaced when the water that has flown through it has exceeded the allowable absorption capacity of the absorbent inside the module, and that water purifiers are known which are provided with a life meter capable of displaying the time of replacing the filter module. However, the known devices are said to be unreliable because they measure only the time of the water flow and this does not provide a reliable indication due to fluctuations in the water flow rate. Therefore said application proposes a domestic water purifier which comprises a constant flow rate valve, a sensor for detecting start and stop of water flow and generating corresponding signals, and means for measuring an integrated operating time based on said signals and displaying a signal when said integrated time reaches a preset value. The application shows various structures of constant flow rate valves, but as to the filter module it shows no structure and states that the invention may utilize various structures of the prior art.

The water purification systems of the prior art, particularly those intended not merely to remove solid substances, but to remove microorganisms and render the water fully potable, are not fully satisfactory from several viewpoints. Their throughput is usually low, so that the filters must be changed frequently, must have a large surface area and, are very expensive.

It is a purpose of this invention to provide an apparatus for drinking purifying water, and which is free of the defects of the existing devices.

It is another purpose of this invention to provide a method for purifying water, which is free of tie defects of prior art methods.

It is a further purpose of this invention to provide a method for optimizing the operation of an apparatus for the purification of drinking water.

Other purposes and advantages of the invention will appear as the description proceeds.

### SUMMARY OF THE INVENTION

The invention provides an apparatus for purifying water, comprising a feed water inlet and a purified water outlet, a filter having depth filter layers and microporous filter membrane layers interposed between said inlet and said outlet, means for driving the water through the filter at a constant flow rate, means for monitoring the time from the installation of the filter, means for monitoring the aggregate time during which the water has flowed through the filter, and means for preventing the flow of water through the filter when either of said times has reached a predetermined threshold value. The means for driving the water through the filter at a constant flow rate may comprise means for applying pressure to the filter and means for controlling the flow rate regardless of changes in the pressure drop across the filter layers, such as a flow restrictor of a known type.

In a preferred embodiment of the apparatus, the depth filter means and microporous membrane means are structured and assembled as will be described hereinafter to constitute a filter device, but said filter device is not, per se, a part of the invention and is not claimed herein per se, but is the subject matter of copending application No. 121884 in the name of Osmotek Ltd.; and the apparatus of the invention could be provided with filters of different structure, provided that they comprise depth filter and microporous membrane filter means which the water successively flows through to be purified.

The filter device of the preferred embodiment is composed of a number of component filter elements. although each filter element by itself would be capable of a filtering action. Such a filter element comprises:

a)—an innermost drainage layer, preferably a substantially open, plastic netting;

b)—two layers of microporous membrane, preferably supported each on a support fabric layer disposed between it and said drainage layer; and more preferably, having a retentivity greater than 95% for microorganisms, said two layers being symmetrically disposed adjacent to the two sides of said drainage layer;

c)—two layers of a depth filter or prefilter (these two terms being used as synonyms in this specification), preferably a glass fiber filter, symmetrically disposed adjacent to the two outer sides of said microporous membrane layers;

d)—said microporous membrane layers and said depth filter layers being sealed together along a top edge, preferably extending above the top of said drainage layer and of said support fabric layers, if present;

e)—said drainage layer and said microporous membrane layers, as well as said support fabric layers, if present, extending at their bottom below the bottom of said depth filter layers, said microporous membrane layers being sealed to said depth filter layers at the bottom of these latter, and

f)—said microporous membrane layers and said depth filter layers being wider than said drainage layer, and said support fabric layers, if any, and being sealed together along their lateral edges.

The terms “top” and “bottom” refer to the position which the filter element will have in the complete filter device.

Said filler device comprises a base plate having a central opening and an upper surface, and a plurality ol elements as hereinbefore defined, arranged parallel to one another and perpendicular to said base plate, and traversing said central opening thereof with the bottom of their depth filter layers at the level of said base plate upper surface, said filter elements being potted to said base plate by filling with adhesive the space between them and the inner edge of said base plate's central opening. The said filter further comprises a sealed housing, in which the base plate with the filter elements potted thereto is enclosed in a tight manner.

In a variant of said filter, the microporous membrane layers and the depth filter or prefilter layers of the aforesaid filter element are sealed together by means of adhesive.

In another variant of said filter, the depth filter layers are laminates, each comprising a layer of porous thermoplastic fabric, and the microporous membrane layers and their support layers are thermoplastic. If the melting temperature of the microporous membrane layer is at least 50° C. higher than those of at least one of the remaining thermoplastic layers, the layers can be sealed together by the application of pressure and heat as better explained hereinafter.

In a typical embodiment of the invention, the apparatus comprises:

a prefilter,

a membrane filter, which can be separate from the prefilter or combined with it in a single structural unit;

a pressure regulator;

a flow meter,

a timer;

a purified water outlet; and

valves and pressure gages, as they may be required.

The invention also provides a method of purifying drinking water which comprises causing the water to flow at a constant flow rate through an apparatus comprising a purification filter, which comprises depth filter or prefilter and microporous membrane filter means, monitoring the time from the installation of the filter, monitoring the aggregate time during which the water is flowing through the filter, and preventing the flow of water through the filter when either of those times has reached a predetermined threshold value. The means for driving the water through the apparatus at a constant flow rate may comprise means for feeding to water to be purified by applying pressure and means for controlling the flow rate, such as a flow restrictor of a known type. The depth filter means and microporous membrane means are preferably structured and assembled as in the filter element hereinbefore defined, so that the filter as a whole is the filter device hereinbefore defined, but the method of the invention could be carried out with apparatus comprising filters of different structure, provided that they comprise depth filter and microporous membrane filter means which the water successively flows through to be purified. The method of this invention is directed to the purification of drinking water, and the purification of water not for drinking purposes is disclaimed herein.

The expression “purifying drinking water”, as used in this specification and claims, includes both rendering water, that is not fit for drinking, potable, and increasing the purity of water that is already drinking water, inasmuch as it is potable. Desirably, the purified water should be substantially sterile.

### BRIEF DESCRIPTION OF THE DRAWINGS

In the drawings:

FIG. 1 is a cross-sectional view of the filter element according to an embodiment of the invention;

FIG. 2 is a front view of the same element;

FIG. 3 is a perspective view of a filter device according to an embodiment of the invention, in an intermediate stage of its manufacture;

FIG. 4 is a cross-sectional view of a filter device according to an embodiment of the invention, taken on a plane passing through the center lines of the filter elements;

FIG. 5 is a cross-sectional view of the filter device of FIG. 4, taken on a plane parallel to the filter element and passing through the center line of the filter element;

FIG. 6 is a cross-sectional view similar to FIG. 1, of a filter element according to a different embodiment of the invention;

FIG. 7 is a diagram in which Total Throughput to reach a Pressure Drop of 2.5 atmospheres, in thousands of liters, is plotted versus Fluid Velocity in cm/min; and

FIG. 8 is a schematic, block diagram illustration of an apparatus according to an embodiment of the invention.

### DETAILED DESCRIPTION OF PREFERRED EMBODIMENTS

As shown in FIG. 8, an apparatus according to the invention comprises an inlet 50, preferably including a pressure gauge and a pressure regulator, of any known type. The pressure for driving the water through the apparatus may be provided by the source of water itself, as by a tap or water main, or, if this is lacking or insufficient, by a pump 51 of any suitable kind. 52 and 53 indicate, respectively, a prefilter and a membrane filter, which can be integrated in a single filter deice 54, as indicated by the broken lines of FIG. 8. The filter is preferably followed by an outlet pressure gauge 55 and by a constant pressure regulator 56. A needle valve 57 may be provided after said regulator. From it, the water flows though a unit 58, which is preferably an integrated component comprising a flow meter, a timer, and a shut-off valve, and reaches the outlet 59.

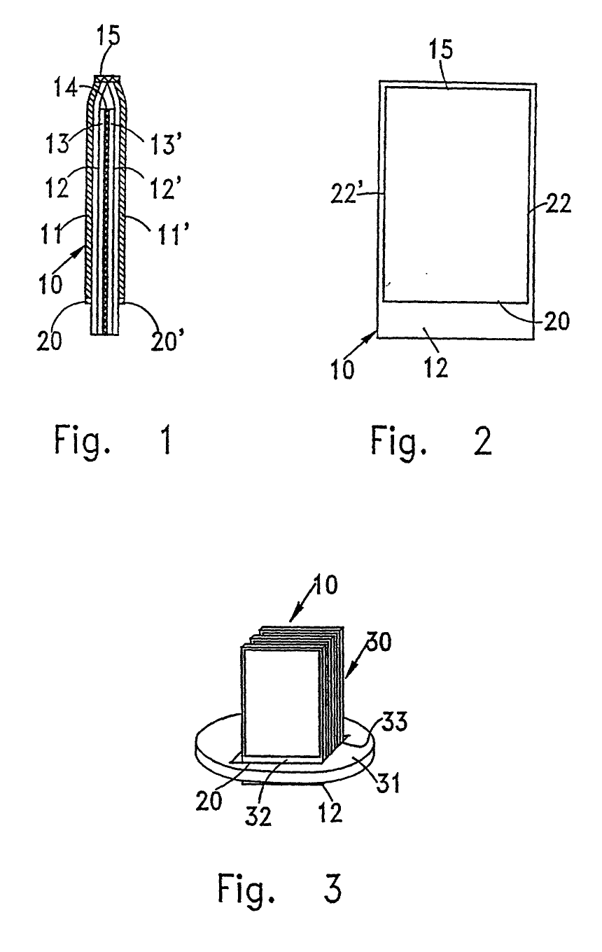

FIGS. 1 to 5, illustrate a filter device used in a preferred embodiment of the apparatus of the invention. As stated hereinbefore, said filter device, per se, is not a part of this invention and is the subject matter of another copending application.

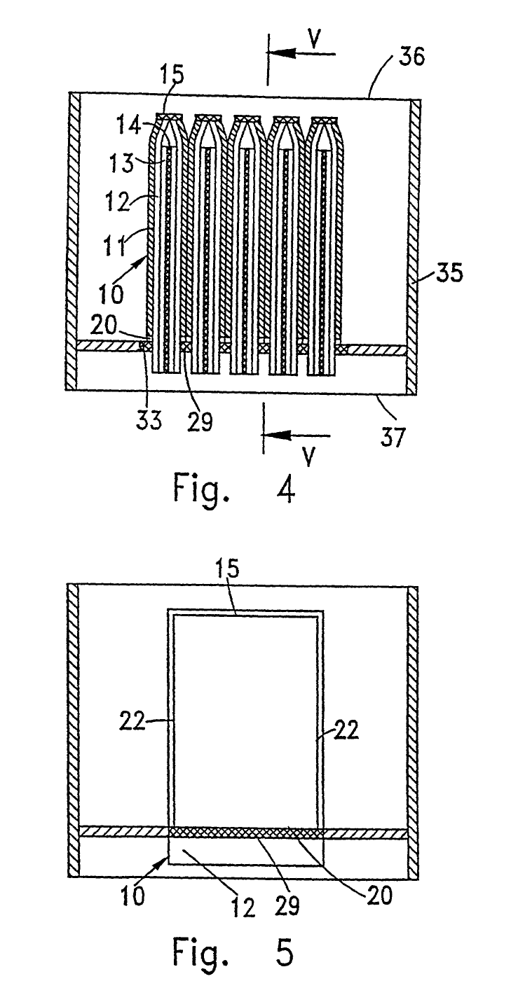

In said figures, a filter element 10 comprises two outer layers of depth filter or prefilter 11 and 11′, which are preferably made of glass fiber. Internally, of layers 11 and 11′, the filter element comprises layers 12 and 12′ of microporous membrane, preferably having a retentivity greater than 95% for microorganisms, which are supported respectively on support fabrics 13 and 13′. All the aforesaid layers are arranged symmetrically about a substantially open plastic netting 14, which constitutes a drainage layer to conduct away the fluid passing through the aforesaid layers 11-11′, 12-12′, and 13-13′. Layers 11-11′ and 12-12′ are congruent and sealed together by means of adhesive, particularly a hot melt adhesive, or by welding. Depth filter layers 11-11′ and the microporous membrane layers 12-12′ are also sealed together at the edges 22. The drainage layer 14 and the fabric support layers 13-13′ do not extend up to the top of the element, viz. to the seal 15, although, in an embodiment of the invention in which welding is used, the layers 13 and 13′ may reach to the edge seal and be sealed thermoplastically together. In FIGS. 1 and 2, both prefilter layers 11-11′ do not reach to the bottom of the element, but the microporous membrane layers, support fabric layers and drainage layers protrude beyond them towards the bottom. The depth filter layers 11-11′ are sealed at 20-20′ to the microporous membrane layers 12-12′. Support layers 13-13′ and drainage layer 14 are narrower than the other layers and do not take part in seals 22.

A number of filter elements 10 are connected to provide a filter device, as illustrated in FIGS. 4 and 5, FIG. 3 indicating an intermediate stage of the manufacture of the filter device. This latter, generally indicated at 30, comprises a base plate 31 having a central opening 32, the peripheral edge of which is indicated at 33. Filter elements 10 are passed through said central opening 32 and placed in such a way that their edges 20 are at the same level as the upper edge of base plate 31. In FIG. 3, central opening 32 is not filled with filter elements 10, but a space is left therein at the front of the device as seen in the drawing.

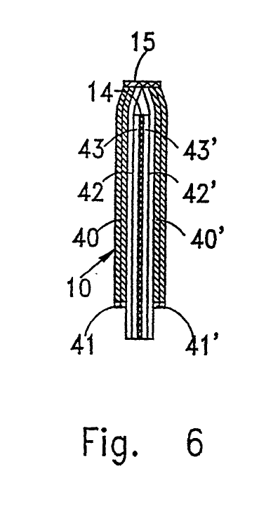

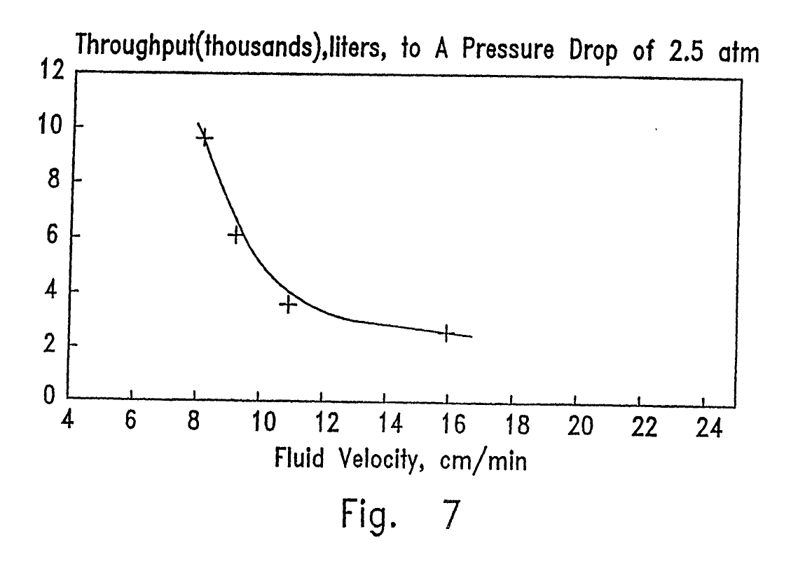

In FIGS. 4 and 5, the filter is complete and the central opening 32 is filled with elements 10. The filter elements are in place, they are potted to the base plate by filling the empty space between them and the inner edge 33 of opening 32 with a suitable adhesive, so that no path of fluid flow exists between the elements 10 and the base plate 31. Base plate 31 is then mechanically sealed into an appropriate filter housing 35. The housing is open at the top, as indicated at 36, to provide an inlet for water to be filtered. The water passes through the various layers of each element 10, entering from outer depth layers 11-11′ and exiting from drainage layer 14, and reaches an opening of housing 35, indicated at 37, which is the filtered water outlet.

In a variant of the filter element, illustrated in FIG. 6, the prefilter layers are replaced by laminates of glass fiber filter layer 4040′ and porous synthetic fabric layers 4141′ of melt temperature T₁, microporous membrane layers 42-42′ are prepared from thermoplastic material having melt temperature T₂, and support layers 4343′ are also of porous synthetic fabric of melt temperature T₃ and are congruent with the preceding layers along edges 15 and 22 (these latter not shown in this figure, but in FIG. 2). Provided that T₂ is at least 50° C. higher than T₁ or T₃, then the aforesaid seams 15 and 22 of the element can be created in a single step by welding under pressure with a hot die whose temperature is greater than either T₁ or T₃. Drinking water is purified, according to the invention, by passing it through a filter element or a plurality of filter elements at a constant flow rate. With filters including a depth filter and a microporous membrane, it has been found that operation of the filter at constant flow rate is greatly advantageous with respect to operation at constant pressure, since a filter device operated constant flow rate requires a much smaller membrane surface area, even ten times smaller, to achieve the same overall throughput of a device operated at constant pressure. A filter device comprised in an apparatus according to an embodiment of the invention, having a filter area of 0.05 sq. meters, may produce 3,000 liters of filtered water at the constant flow rate of 2 liters/minute, when operating on tap water with an average filtration index value of 10, and need not be changed, before producing said volume of filtered water, more than once in three months.

When operating at constant pressure, the following phenomena occur in a filter comprising a prefilter and a microporous membrane. At the beginning of the process, the hydraulic resistance of the filter is lowest, the flow rate is at a maximum and the efficiency of the prefilter is lowest, since this is decreased as the velocity of the particles increases. As a consequence, particles pass through the prefilter and are captured on the surface of the microporous membrane, blocking pores and reducing the flow rate. As the filtration continues, the fluid velocity continues to decrease and as a result, the capture efficiency of the prefilter finally improves. The resistance of the prefilter and membrane increases until the combined resistance is such that the filter no longer provides a useful flow rate. When operating at constant flow rate, it is possible to choose a fluid velocity such that a maximum number of particles are captured by the prefilter from the beginning of the filtration process, so that the total throughout of the filter is greatly increased.

The general method of optimization of the operation of an apparatus according to the aforesaid preferred embodiment , viz. comprising a filter as hereinbefore particularly described, and more generally of a filter comprised of a depth filter and a microporous membrane filter. consists of the following steps:

1. A filter element operating at some initially convenient constant flow rate, is tested until a predetermined total pressure drop across the filter has been reached.

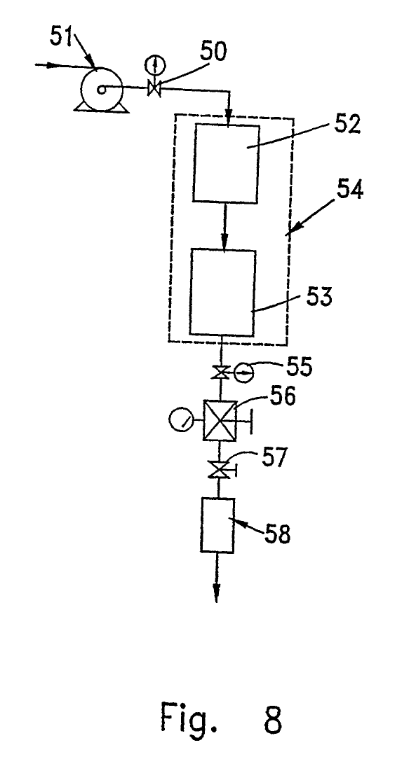

2. The results are plotted as in FIG. 7, in which Total Throughput is plotted versus Fluid Velocity (obtained by dividing the flow rate by the filter element surface area).

3. The testing is continued, either by changing the constant flow rate, or by changing the surface area of the elements, until the whole of FIG. 7 has been generated.

4. The desired total throughput is chosen, and a convenient combination of constant flow rate and surface area of membrane element is then chosen.

5. The filter is operated in a constant flow mode, in accordance with number 4 above.

Data for Total Throughput (to a pressure drop of 2.5 bar) are shown in FIG. 7 for a flat sheet membrane filter element containing a glass fiber depth filter and a nominal 0.2 micron pore size microporous membrane. One can clearly see that when operated in constant flow, below a critical velocity, the Total Throughput of the membrane filter can be increased several fold.

The prefilter or depth filter layer 12 is preferably any prefilter material known in the art and could include, without being limited to fibrous or particulate, inorganic or organic material such as glass fiber, carbon, cellulose, polyolefins or other synthetic polymeric materials. The prefilter can also be in the form of a compressed, highly porous block of fibers, microfibers or particles, containing pores at least 5× the diameter of the pores in the membrane, or in the form of a woven or non-woven fabric, all of which are known in the art. A non-woven glass fiber material, containing no binding agents, with an approximate thickness of 450 microns and a nominal particle removal rating of 1 micron, is especially preferred for use in the filtration of tap water.

Microporous membrane layer 14 is preferably a microporous filter with pores between 0.05 and 0.45 microns, and which is commonly fabricated from high temperature thermoplastics polymers, such as polysulphone, nylon, polyvinylidene fluoride, or inorganic materials, such as ceramic materials, or metals, and has a water permeability between 0.05-30 cc/sq. cm/sec/atm, as are commonly known in the art, as those described in chapters 2-4 of “Filtration in the Pharmaceutical Industry”, by Theodore H. Melzer, Marcel Dekker Inc. N.Y., Copyright 1987, ISBN 0-8247-7519-8.

Membrane support layer 16 is preferably a woven or non-woven fabric of a synthetic material which does not swell or distort in water. Non-woven fabrics prepared from polyolefins are particularly useful for this purpose, as their range of melting temperature is well below that for many of the polymers used to fabricate membrane layer 14. Ideally this layer should have a maximal permeability, but anyway no less than ten times that of the membrane layer supported.

Plastic netting 18, for separating layers of filter material in order to create a fluid path, is available in a wide number of thermoplastic materials, prepared by extrusion or other processes, such as weaving continuous plastic filaments, and is well known in the art. Examples of such material are the polypropylene nets manufactures by Nalle Plastics, Austin, Tex. under the trademark Naltex.

The following example illustrates the performance of an apparatus according to the aforesaid preferred embodiment of the invention.

A membrane filter element with an effective filter surface area of approximately 24 sq. cm. was prepared from A/E glass fiber prefilter material (Gelman Sciences, Ann Arbor, Mich., USA), Super 200 microporous membrane (Gelman Sciences, Ann Arbor, Mich., USA), a polypropylene non-woven fabric as the membrane support layer and a polypropylene net (Nalle Plastics, Texas, USA) to create the drain path. Epoxy adhesive was used to create the glue seams. A number of such elements were potted with epoxy adhesive into a 4 mm thick plastic base plate to form a filter assembly, in order to create filter assemblies with effective filtration surface areas between 50 and 500 sq. cm. Hot melt adhesives, approved for direct contact with liquid food, are available on the market, e.g. from the Bostik, H.B. Fuller and Collano companies.

Each filter assembly was secured in an appropriate housing and its integrity was first integrity tested by the bubble point technique. After a short water flush, the entrance to the housing was connected to a source of gas pressure, and the exit tube conducting filtered water from the housing was placed in a vessel of water. The pressure of the gas was slowly raised until the first steady stream of bubbles was seen to issue from the housing exit tube. This pressure, 3.2 atmospheres, referred to as the bubble point, was found to be within 0.1 atmospheres of that specified by the manufacturer for the Supor 200 membrane, thereby confirming that the housing and the filter assembly were integral, and that the membrane was of the designated nominal pore size.

A water purifying apparatus according to an embodiment of the invention and comprising said filter assembly, was tested at a constant flow rate of 2 liters per minute. Pressure gauges before and after the apparatus measured the pressure drop, and the test was concluded when the pressure drop exceeded 2.6 bar. An integrating water meter measured the cumulative throughput. The test data for such assemblies are shown in FIG. 7. The quality of the water was periodically monitored by the silt density or filtration index technique, and the index was found to vary between 8 and 15 during the day, with an average value of 10-12.

With reference to FIG. 7, a filter can be designed that uses a minimum amount of prefilter and membrane filter in order to achieve a predetermined goal of filter throughput and flow rate: e.g., a filter as herein described, which is required to provide a total throughput of 10,000 liters at a maximum pressure drop of 2.5 atmospheres and flow rate of 2 liters/min.

As shown by FIG. 7, the maximum fluid velocity for said throughput should not exceed 8 cm/min. Since the required flow rate is 2000 cc/min, the required filter surface area (both the prefilter and the membrane filter) is the total flow rate divided by the velocity, or 250 sq.cm. Of course, it is possible to provide a greater area in order to insure the filter performance and account for possible variations in the quality of the water (which, in the case of the data of FIG. 7, was found to be quite constant).

As a specific embodiment of the invention, with reference to the schematic drawing of FIG. 8, a standard centrifugal pump with a capacity of 10-20 liters per minute at a pressure of up to 10 atm. was attached to a 50 liter tank which was constantly refilled from a source of tap water. The pump outlet was followed by a standard 0-6 atmosphere water regulator equipped with gauge (Braukmann GbH, Ger.), and set to an inlet pressure of 4 atmospheres. This was attached to a filter housing containing a filter element fabricated as described herein. A pressure gauge at the outlet was followed by a second regulator set at 0.5 atmosphere, the lowest setting at which it would effectively regulate. This was followed by an integrating water meter (Arad ltd., Israel) and a ball flow meter with an integral needle valve (Fisher Porter, USA). A separate electronic controller controlled a standard solenoid valve for the shutoff according to time. While embodiments of the invention have been described for the purpose of illustration, it will be understood that the invention may be carried into practice by skilled persons with many modifications, variations and adaptations, without departing from its spirit or exceeding the scope of the claims.

What is claimed is:

1. Apparatus for purifying drinking water, comprising:
a feed water inlet and a purified water dispensing outlet and a filter device intermediate said inlet and said outlet,
characterized in that the filter device comprises a prefilter and a microporous membrane, and
wherein said apparatus is configured to operate said filter device at a constant flow rate over the useful life of said filter device.

2. Apparatus according to claim 1, further comprising:
a timer for monitoring the time from the installation of the filter device,
integrator for monitoring the aggregate time during which the water has flowed through the filter device,
and shutoff controller operatively connected to said timer and said integrator such as to prevent the flow of water through the filter device when either of said times has reached a predetermined threshold value.

3. Apparatus according to claim 1, wherein said filter device is configured to apply pressure to said filter device and control the flow rate therethrough regardless of changes in pressure.

4. Apparatus according to claim 1, wherein said filter device, operating at a constant flow rate, comprises a flow restrictor.

5. Domestic apparatus for purifying drinking water, according to claim 1, wherein said filter device comprises at least a filter element comprising:
I) an innermost drainage layer having two sides;
II) two layers of microporous membrane having two outer sides, symmetrically disposed adjacent the two sides of said drainage layer;
III) two layers of a prefilter, symmetrically disposed adjacent to the two outer sides of said microporous membrane layers;
IV) said microporous membrane layers and said prefilter layers being integrally sealed along a top edge;
V) said drainage layer and said microporous membrane layers being sealed to said prefilter layers at the bottom of said prefilter layers; and
VI) said microporous membrane layers and said depth filter layers being wider than said drainage layer; and being sealed together along lateral edges of said microporous membrane layers and said depth filter layers; and the filter device further comprises:
a) one or more of such filter elements arranged parallel to one another and perpendicular to a base plate having a central opening and an upper surface, and traversing said central opening thereof with the bottom of their prefilter layers at the level of said base plate upper surface;
b) said filter elements being integrally adhered to the base plate by filling with adhesive the space between them and said inner edge of said base plate's central opening;
c) said filter elements and base plate being integrally sealed into a fluid pressurizable housing such that unfiltered water entering the housing is forced to pass through the filter elements in order to exit from the housing in a filtered state.

6. Method of purifying drinking water; comprising causing the water to flow at a constant flow rate through a purification filter device comprising said prefilter and said microporous membrane.

7. Method according to claim 6, further comprising monitoring the time from the installation of the filter device, monitoring the aggregate time during which the water is flowing through the filter device, and preventing the flow of water through the filter device when either of those times has reached a predetermined threshold value.

8. Method for operating a filter according to claim 5, which comprises the following steps:
I) Operating a filter element at an initial constant flow rate until a predetermined total pressure drop across the filter has been reached.
II) During the said operation, monitoring and plotting the total throughput versus the fluid velocity, obtained by dividing the flow rate by the filter element surface area.
III) Repeating the above operations at different fluid velocities, determined by changing the flow rate or the filter surface area, and plotting the throughput as a function of the fluid velocity.
IV) Choosing the desired throughput, and reading from the aforesaid plotting, the corresponding fluid velocity.
V) Choosing a combination of flow rate and surface areas of the filter element area corresponding to the chosen throughput.

9. Apparatus for purifying drinking water, comprising:
a feed water inlet and a purified water dispensing outlet and a filter device intermediate said inlet and said outlet,
characterized in that the filter device comprises prefilter means and a microporous membrane, and
wherein said apparatus further comprises constant flow rate means for operating said filter device at a constant flow rate over the useful life of said filter device.

10. Apparatus according to claim 9, further comprising:
timing means for monitoring the time from the installation of the filter device,
integrating means for monitoring the aggregate time during which the water has flowed through the filter device, and
shutoff means operatively connected to said timing means and said integrating means such as to prevent the flow of water through the filter device when either of said times has reached a predetermined threshold value.

11. Apparatus according to claim 9, wherein the means for operating said filter device at a constant flow rate comprises means for applying pressure to the filter device and means for controlling the flow rate therethrough regardless of changes in pressure.

12. Apparatus according to claim 9, wherein the means for controlling the flow rate comprises a flow restrictor.

13. Domestic apparatus for purifying drinking water, according to claim 9, wherein said filter device comprises at least a filter element comprising:
I) an innermost drainage layer having two sides;
II) two layers of microporous membrane having two outer sides, symmetrically disposed adjacent the two sides of said drainage layer;
III) two layers of a prefilter, symmetrically disposed adjacent to the two outer sides of said microporous membrane layers;
IV) said microporous membrane layers and said prefilter layers being integrally sealed along a top edge;
V) said drainage layer and said microporous membrane layers being sealed to said prefilter layers at the bottom of said prefilter layers; and
VI) said microporous membrane layers and said depth filter layers being wider than said drainage layer; and being sealed together along lateral edges of said microporous membrane layers and said depth filter layers; and the filter device further comprises:
a) one or more of such filter elements arranged parallel to one another and perpendicular to a base plate having a central opening and an upper surface, and traversing said central opening thereof with the bottom of their prefilter layers at the level of said base plate upper surface;
b) said filter elements being integrally adhered to the base plate by filling with adhesive the space between them and said inner edge of said base plate's central opening;
c) said filter elements and base plate being integrally sealed into a fluid pressurizable housing such that unfiltered water entering the housing is forced to pass through the filter elements in order to exit from the housing in a filtered state.

14. Method of purifying drinking water; comprising causing the water to flow at a constant flow rate through a purification filter device comprising prefilter means and microporous membrane filter means.

15. Method according to claim 14, further comprising monitoring the time from the installation of the filter device, monitoring the aggregate time during which the water is flowing through the filter device, and preventing the flow of water through the filter device when either of those times has reached a predetermined threshold value.

16. Method for operating a filter according to claim 13, which comprises the following steps:
VI) Operating a filter element at an initial constant flow rate until a predetermined total pressure drop across the filter has been reached.
VII) During the said operation, monitoring and plotting the total throughput versus the fluid velocity, obtained by dividing the flow rate by the filter element surface area.
VIII) Repeating the above operations at different fluid velocities, determined by changing the flow rate or the filter surface area, and plotting the throughput as a function of the fluid velocity.
IX) Choosing the desired throughput, and reading from the aforesaid plotting, the corresponding fluid velocity.
X) Choosing a combination of flow rate and surface areas of the filter element area corresponding to the chosen throughput.
